(19) United States
(12) Patent Application Publication
(10) Pub. No.: US 2006/0120110 A1
(43) Pub. Date: Jun. 8, 2006

(54) Light guide plate and method for manufacturing the same

(75) Inventors: Ching-Huang Lin, Miao-Li (TW); Wen-Bin Lin, Miao-Li (TW); Chih-Hung Chang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/294,241

(22) Filed: Dec. 5, 2005

(30) Foreign Application Priority Data
Dec. 3, 2004 (TW) 93137375

(51) Int. Cl. F21V 7/04

(52) U.S. Cl. 362/615

(57) ABSTRACT

A light guide plate (20) includes a main body, a light incident surface (201), a light emitting surface (202), and a plurality of light diffusing structures (204), arranged within the main body according to a predetermined pattern. The light diffusing structures are formed using an engraving method. The light diffusing structures are formed within the light guide plate, which protects the light diffusing structures from being damaged. In addition, the laser engraving method and the ultrasonic engraving method can be conveniently controlled, so that the arrangement and distribution of the light diffusing structures can be easily controlled. This enables the light guide plate to be configured with optimal optical characteristics, thereby yielding an improved light utilization ratio.

### BACKGROUND

1. Field of the Invention

The present invention relates to a light guide plate and a method for manufacturing the light guide plate.

2. General Background

Liquid crystal display (LCD) devices are commonly used as display devices for compact electronic apparatuses, because they not only provide good quality images with little power but also are very thin. The liquid crystal molecules in a liquid crystal display do not emit any light themselves. The liquid crystal molecules have to be lit by a light source so as to clearly and sharply display text and images. Thus, a backlight module for an LCD is generally needed. A light guide plate is generally needed in a backlight module.

A typical light guide plate is shown in FIG. 17. The light guide plate 10 includes a light incident surface 110, a light emitting surface 160 adjoining the light incident surface 110, a bottom surface 140 opposite to the light emitting surface 160, and a plurality of light diffusing structures 120 arranged on the bottom surface 140. The light diffusing structures 120 on the bottom surface 140 generally comprise either concavities or protrusions. The light diffusing structures 120 can eliminate total internal reflection (TIR) by diffusing light beams, and can improve the uniformity of light emitted from the light emitting surface 160. However, the light diffusing structures 120 are liable to be damaged during transportation or handling of the light guide plate 10. In addition, because the light diffusing structures 120 are located at the bottom surface 140, light within the light guide plate 10 has to travel relatively far before reaching the light diffusing structures 120, and thereafter has to travel relatively far to be able to exit the light guide plate 10 through the light emitting surface 160. This may be considered as unduly low utilization of light by the light guide plate 10.

Another typical light guide plate is shown in FIG. 18. The light guide plate 10′ includes a light incident surface 110′, a light emitting surface 160′ adjoining the light incident surface 110′, a bottom surface 140′ opposite to the light emitting surface 160′, and a plurality of light diffusing particles 120′ randomly arranged within a main body of the light guide plate 10′.

Because the light diffusing particles 120′ are arranged within the light guide plate 10′, the light diffusing particles 120′ are protected from being damaged. Furthermore, the traveling distance of light beams within the light guide plate 10′ is shortened, which results in improved light utilization. However, the light guide plate 10′ is generally formed by way of injection molding. During the molding process, the light diffusing particles 120′ are injected into the mold together with a base material of the light guide plate 10′. Thus the light diffusing particles 120′ are randomly distributed within the light guide plate 10′. In other words, it is difficult to accurately configure the optical characteristics of the light guide plate 10′. In particular, it is difficult to control the uniformity of light that will be output from the light emitting surface 160′ of the light guide plate 10′ in use.

What is needed, therefore, is a light guide plate that has light diffusing structures that are protected from being damaged, the light diffusing structures being arranged to provide optimum optical characteristics for the light guide plate.

### SUMMARY

In one preferred embodiment, a light guide plate includes a main body, a light incident surface, a light emitting surface, and a plurality of light diffusing structures arranged within the main body according to a predetermined pattern. The light diffusing structures are formed using an engraving method.

In another preferred embodiment, a method for manufacturing a light guide plate includes the following steps: providing a light guide plate preform, and forming a plurality of light diffusing structures in the light guide plate preform using an engraving method. The engraving method may be a laser engraving method or an ultrasonic engraving method.

The light diffusing structures are formed within the light guide plate, which protects the light diffusing structures from being damaged. In addition, the laser engraving method and the ultrasonic engraving method can be conveniently controlled, so that the arrangement and distribution of the light diffusing structures can be easily controlled. This enables the light guide plate to be configured with optimal optical characteristics, thereby yielding an improved light utilization ratio.

Other advantages and novel features will become more apparent from the following detailed description of preferred embodiments when taken in conjunction with the accompanying drawings, in which:

### BRIEF DESCRIPTION OF THE DRAWINGS

FIG. 1 is a schematic, isometric view of a light guide plate according to a first embodiment of the present invention;

FIG. 2 is a schematic, top view of the light guide plate of FIG. 1;

FIG. 3 is a schematic, side view of a light guide plate according to a second embodiment of the present invention;

FIG. 4 is a schematic, side view of a light guide plate according to a third embodiment of the present invention;

FIG. 5 is a schematic, side view of a light guide plate according to a fourth embodiment of the present invention;

FIG. 6 is a schematic, side view of a light guide plate according to a fifth embodiment of the present invention;

FIG. 7 is a schematic, side view of a light guide plate according to a sixth embodiment of the present invention;

FIG. 8 is a schematic, side view of a light guide plate according to a seventh embodiment of the present invention;

FIG. 9 is a schematic, top view of the light guide plate of FIG. 8;

FIG. 10 is a schematic, top view of a light guide plate according to an eighth embodiment of the present invention;

FIG. 11 is a schematic, top view of a light guide plate according to a ninth embodiment of the present invention;

FIG. 12 is a schematic, side view of a light guide plate according to a tenth embodiment of the present invention;

FIG. 13 is an enlarged view of a circled portion XIII of FIG. 12;

FIG. 14 is a schematic, side view of a light guide plate according to an eleventh embodiment of the present invention;

FIG. 15 is an enlarged view of a circled portion XV of FIG. 14;

FIG. 16 is a schematic, side view of a light guide plate according to a twelfth embodiment of the present invention;

FIG. 17 is a schematic, isometric view of a conventional light guide plate; and

FIG. 18 is a schematic, simplified, isometric view of another conventional light guide plate.

### DETAILED DESCRIPTION OF PREFERRED EMBODIMENTS

Reference will now be made to the drawings to describe the preferred embodiments in detail.

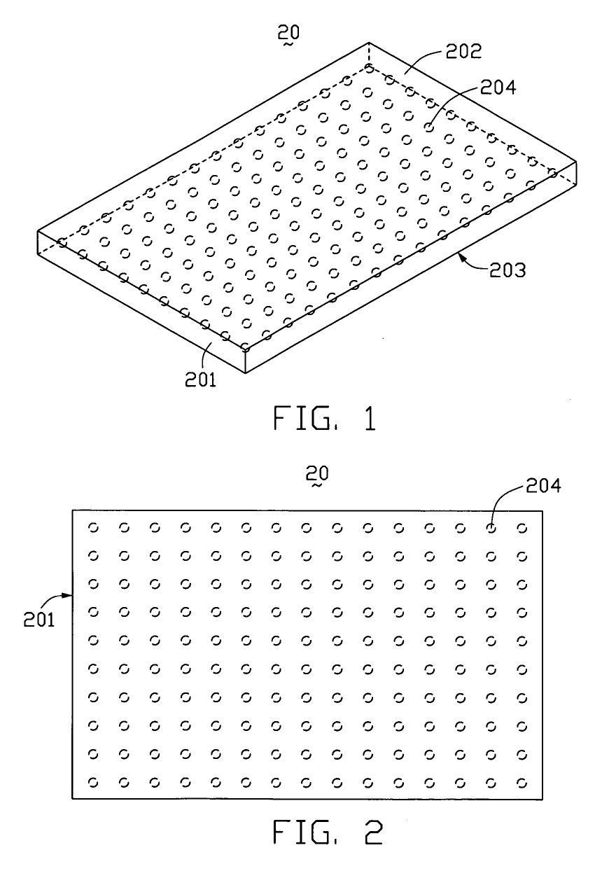

Referring to FIG. 1 and FIG. 2, a flat light guide plate 20 according to a first embodiment of the present invention includes a light incident surface 201,, a light emitting surface 202 adjoining the light incident surface 201, and a bottom surface 203 opposite to the light emitting surface 202. The light guide plate 20 further includes a plurality of light diffusing structures 204 formed therein. The light diffusing structures 204 can be formed by a laser engraving method or an ultrasonic engraving method (see below). In the illustrated embodiment, the spherical light diffusing structures 204 are spherical, and are arranged in a single plane in a regular m×n type of matrix within the light guide plate 20.

Light beams from a light source (not shown) adjacent to the light incident surface 201 enter the light guide plate 20 through the light incident surface 201, are scattered when reaching the light diffusing structures 204, and finally are emitted through the light emitting surface 202 uniformly. Because light beams are scattered by the light diffusing structures 204, a distance traveled by such light beams in the light guide plate 20 is shortened. This improves a light utilization ratio of the light guide plate 20. Furthermore, because the light diffusing structures 204 are formed in the light guide plate 20 by a laser engraving method or an ultrasonic engraving method, the arrangement and distribution of the light diffusing structures 204 can be easily controlled. This enables the light guide plate 20 to be configured with optimal optical characteristics.

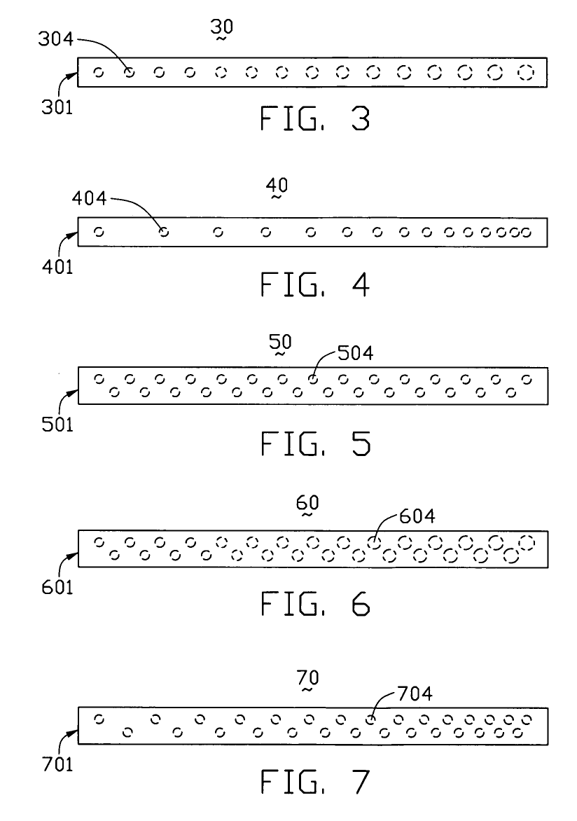

FIG. 3 is a schematic side view of a light guide plate according to a second embodiment of the present invention. The light guide plate 30 is similar to the light guide plate 20 of the first embodiment. However, the light guide plate 30 includes a light incident surface 301 and a plurality of light diffusing structures 304. The light diffusing structures 304 progressively increase in size with increasing distance away from the light incident surface 301.

FIG. 4 is a schematic side view of a light guide plate according to a third embodiment of the present invention. The light guide plate 40 is similar to the light guide plate 20 of the first embodiment. However, the light guide plate 40 includes a light incident surface 401 and a plurality of light diffusing structures 404. A pitch between two adjacent light diffusing structures 404 progressively decreases with increasing distance away from the light incident surface 401.

FIG. 5 is a schematic side view of a light guide plate according to a fourth embodiment of the present invention. The light guide plate 50 is similar to the light guide plate 20 of the first embodiment. However, the light guide plate 50 includes a light incident surface 501 and a plurality of light diffusing structures 504. The light diffusing structures 504 are arranged in two parallel planes within the light guide plate 50. The light diffusing structures 504 in each of the planes are medially offset from the light diffusing structures 504 in the adjacent plane.

FIG. 6 is a schematic side view of a light guide plate according to a fifth embodiment of the present invention. The light guide plate 60 is similar the light guide plate 40 of the fourth embodiment. However, the light guide plate 60 includes a light incident surface 601 and a plurality of light diffusing structures 604. The light diffusing structures 604 are arranged in two substantially parallel planes within the light guide plate 60. In each plane, the light diffusing structures 604 progressively increase in size with increasing distance away from the light incident surface 601. The light diffusing structures 604 in each of the planes are medially offset from the light diffusing structures 604 in the adjacent plane.

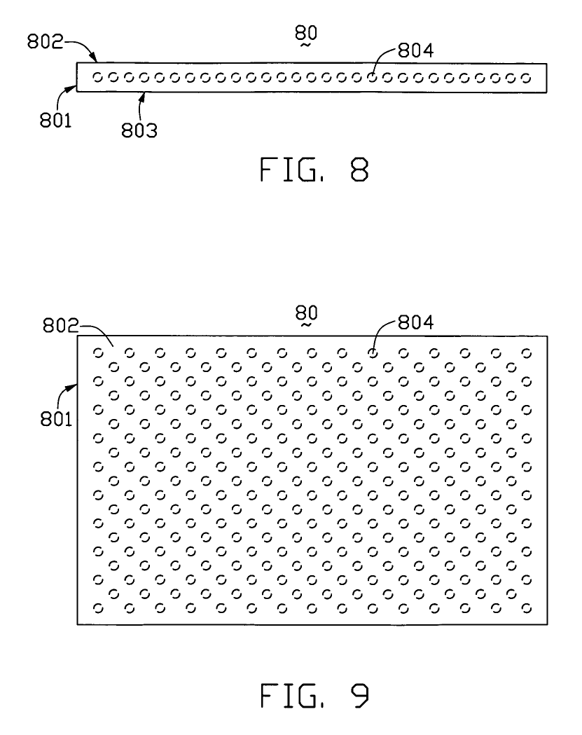

FIG. 7 is a schematic side view of a light guide plate according to a sixth embodiment of the present invention. The light guide plate 70 is similar to the light guide plate 40 of the fourth embodiment. However, the light guide plate 70 includes a light incident surface 701 and a plurality of light diffusing structures 704. The light diffusing structures 704 are arranged in two parallel planes within the light guide plate 70. In each plane, a pitch between two adjacent light diffusing structures 704 progressively decreases with increasing distance away from the light incident surface 701. The light diffusing structures 704 in each of the planes are substantially medially offset from the light diffusing structures 704 in the adjacent plane.

Referring to FIG. 8 and FIG. 9, a light guide plate 80 according a seventh embodiment of the present invention includes a light incident surface 801, a light emitting surface 802 adjoining the light incident surface 801, a bottom surface 803 opposite to the light emitting surface 802, and a plurality of light diffusing structures 804. The light diffusing structures 804 are uniformly arranged in a single plane within the light guide plate 80, in a generally rectangular matrix. The light diffusing structures 804 in each column of light diffusing structures 804 are medially staggered in relation to the light diffusing structures 804 in each adjacent column of light diffusing structures 804. Similarly, the light diffusing structures 804 in each row of light diffusing structures 804 are medially staggered in relation to the light diffusing structures 804 in each adjacent row of light diffusing structures 804.

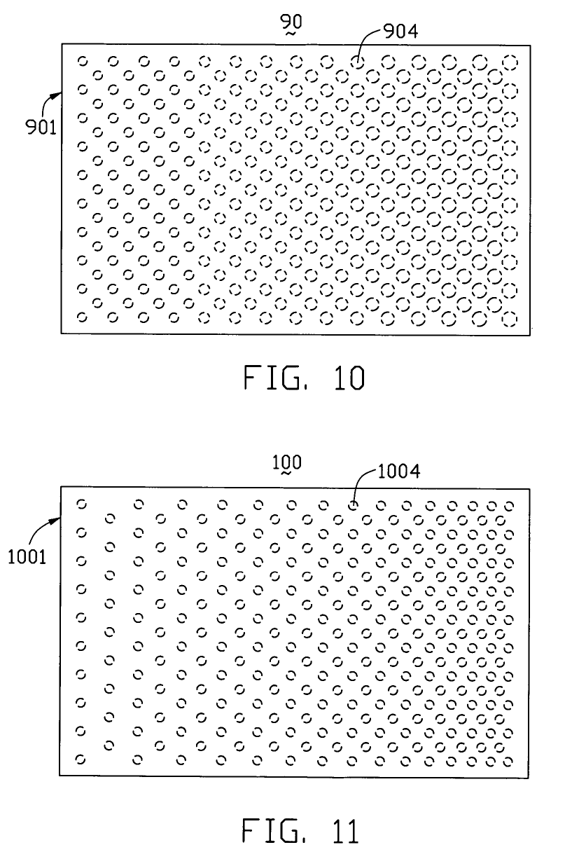

FIG. 10 is a schematic top view of a light guide plate according to an eighth embodiment of the present invention. The light guide plate 90 is similar to the light guide plate 80 of the seventh embodiment. However, the light guide plate 90 includes a light incident surface 901 and a plurality of light diffusing structures 904. The light diffusing structures 904 are arranged in a single plane within the light guide plate 90, in a generally rectangular matrix. The light diffusing structures 904 in each column are medially staggered in relation to the light diffusing structures 904 in each adjacent column. Similarly, the light diffusing structures 904 in each row are medially staggered in relation to the light diffusing structures 904 in each adjacent row. In each row, the light diffusing structures 904 progressively increase in size with increasing distance away from the light incident surface 901.

FIG. 11 is a schematic top view of a light guide plate according to a ninth embodiment of the present invention. The light guide plate 100 is similar to the light guide plate 80 of the seventh embodiment. However, the light guide plate 100 includes a light incident surface 1001 and a plurality of light diffusing structures 1004. The light diffusing structures 1004 are arranged in a single plane within the light guide plate 100, in a generally rectangular matrix. The light diffusing structures 1004 in each column are medially staggered in relation to the light diffusing structures 1004 in each adjacent column. Similarly, the light diffusing structures 1004 in each row are medially staggered in relation to the light diffusing structures 1004 in each adjacent row. In each row, a pitch between two adjacent light diffusing structures 1004 progressively decreases with increasing distance away from the light incident surface 1001.

Referring to FIG. 12 and FIG. 13, a light guide plate 110 according a tenth embodiment of the present invention includes a plurality of light diffusing structures 1104 formed therein. The light diffusing structures 1104 are formed as a continuous series of generally V-shaped light diffusing patterns 114. Each V-shaped light diffusing pattern may comprise two generally planar arrays of light diffusing structures 1104. Alternatively, each V-shaped light diffusing pattern may comprise two generally linear arrays of light diffusing structures 1104.

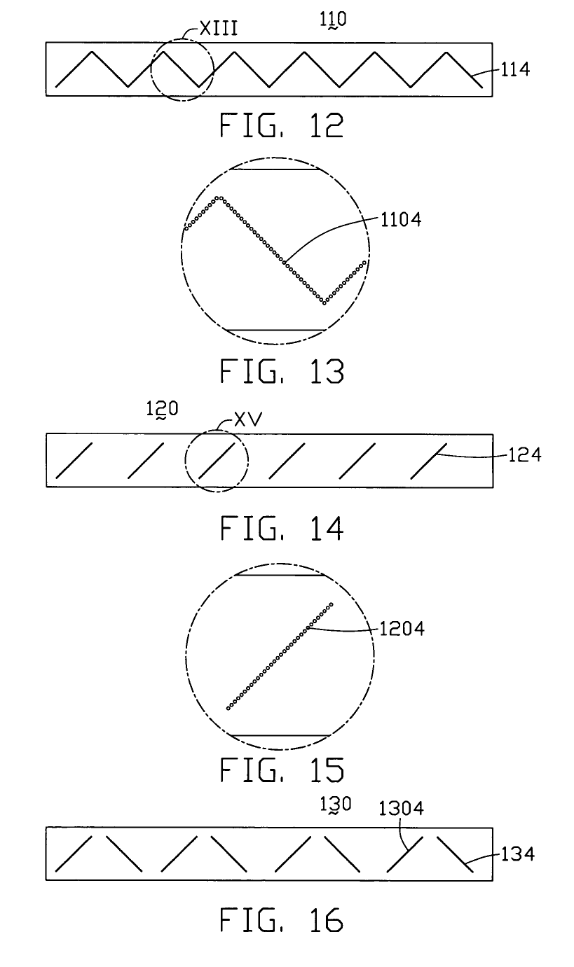

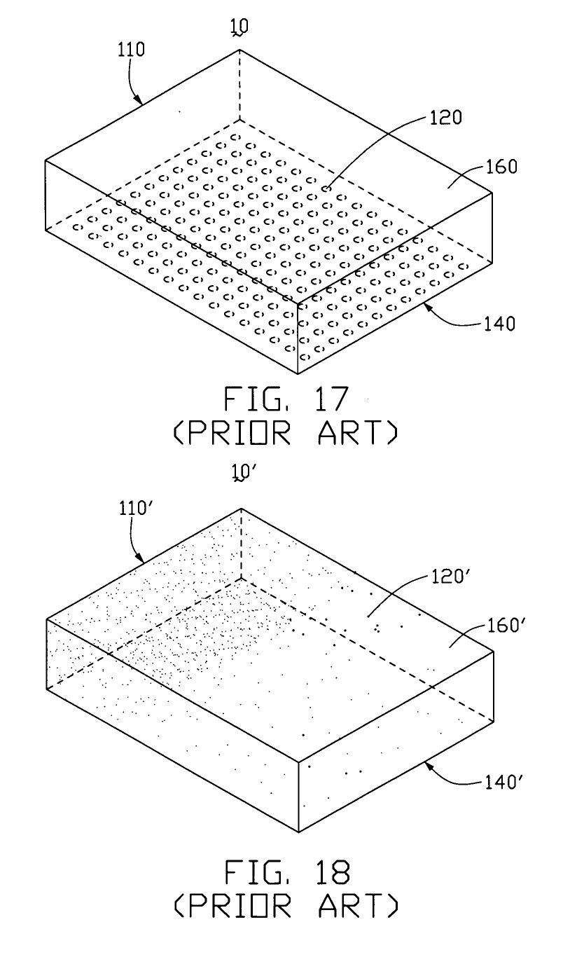

Referring to FIG. 14 and FIG. 15, a light guide plate 120 according to an eleventh embodiment of the present invention includes a plurality of light diffusing structures 1204 therein. The light guide plate 120 is similar to the light guide plate 110 of the tenth embodiment. However, the light guide plate 120 includes a plurality of light diffusing structures 1204 formed therein. The light diffusing structures 1204 are arranged as a plurality of separate, inclined light diffusing patterns 124. In the illustrated embodiment, the light diffusing patterns 124 are all parallel to each other. The light diffusing patterns 124 can comprise generally planar arrays of light diffusing structures 1204, or generally linear arrays of light diffusing structures 1204. In alternative embodiments, the light diffusing patterns 124 can have curved profiles.

FIG. 16 is a schematic side view of a light guide plate according to a twelfth embodiment of the present invention. The light guide plate 130 is similar to the light guide plate 120 of the eleventh embodiment. However, the light guide plate 130 includes a plurality of light diffusing structures 1304 formed therein. The light diffusing structures 1304 are arranged as a plurality of separate, inclined light diffusing patterns 134. Each light diffusing pattern 134 is symmetrically opposite to each adjacent light diffusing pattern 134. The light diffusing patterns 134 can comprise generally planar arrays of light diffusing structures 1304, or generally linear arrays of light diffusing structures 1304. In alternative embodiments, the light diffusing patterns 134 can have curved profiles.

In alternative embodiments, the light diffusing structures can be arranged in tapered formations, hemispherical patterns, or symmetrically opposite pyramidal patterns. The light diffusing structures can be arranged in three or more planes. The light diffusing structures can be arranged according to the configuration(s) of one or more light sources. For example, when a light guide plate includes two opposite light incident surfaces, each light incident surface is adapted to be located adjacent to a respective light source. In such cases, the density of the light diffusing structures can be at a maximum at the center of the light guide plate. Further, the light emitting surface can be roughened in order to enhance the directionality of output light beams.

The light diffusing structures are formed within the light guide plate, which protects the light diffusing structures from being damaged. In addition, the laser engraving method and the ultrasonic engraving method can be conveniently controlled, so that the arrangement and distribution of the light diffusing structures can be easily controlled. This enables the light guide plate to be configured with optimal optical characteristics, thereby yielding an improved light utilization ratio.

The above-mentioned laser engraving method or ultrasonic engraving method for manufacturing a light guide plate includes the following steps: providing a light guide plate preform; and forming a plurality of light diffusing structures in the light guide plate preform using laser engraving or ultrasonic engraving. The light guide plate is thereby formed. Typically, the light guide plate perform is made of PMMA (polymethyl methacrylate) or PC (polycarbonate).

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A light guide plate, comprising:
a main body;
a light incident surface;
a light emitting surface; and
a plurality of light diffusing structures arranged within the main body according to a predetermined pattern.

2. The light guide plate as claimed in claim 1, wherein the light diffusing structures are formed using an engraving method.

3. The light guide plate as claimed in claim 2, wherein the engraving method is a laser engraving method.

4. The light guide plate as claimed in claim 2, wherein the engraving method is an ultrasonic engraving method.

5. The light guide plate as claimed in claim 1, wherein the light emitting surface adjoins the light incident surface.

6. The light guide plate as claimed in claim 1, wherein the light diffusing structures are arranged in tapered formations, hemispherical patterns, or symmetrically opposite pyramidal patterns.

7. The light guide plate as claimed in claim 1, wherein the light diffusing structures are uniformly arranged in a plane.

8. The light guide plate as claimed in claim 7, wherein the light diffusing structures are arranged in a regular m x n type of matrix.

9. The light guide plate as claimed in claim 1, wherein the light diffusing structures are arranged in two parallel planes.

10. The light guide plate as claimed in claim 1, wherein the light diffusing structures progressively increase in size with increasing distance away from the light incident surface.

11. The light guide plate as claimed in claim 1, wherein a pitch between two adjacent light diffusing structures progressively decreases with increasing distance away from the light incident surface.

12. The light guide plate as claimed in claim 7, wherein the light diffusing structures in each of columns of an array of the light diffusing structures are medially staggered in relation to the light diffusing structures in each adjacent column of the array of light diffusing structures.

13. The light guide plate as claimed in claim 1, wherein the light diffusing structures are arranged as at least one continuous series of generally V-shaped light diffusing patterns.

14. The light guide plate as claimed in claim 1, wherein the light diffusing structures are arranged as a plurality of separate, inclined light diffusing patterns.

15. The light guide plate as claimed in claim 14, wherein the inclined light diffusing patterns are planar.

16. The light guide plate as claimed in claim 14, wherein the inclined light diffusing patterns are parallel to each other.

17. The light guide plate as claimed in claim 14, wherein adjacent of the inclined light diffusing patterns are symmetrically opposite to each other.

18. A light guide plate, comprising:
a main body surrounded by a plurality of boundary surfaces of which one is a light incident surface and another is a light emitting surface; and
a plurality of orderly arranged light diffusing structures arranged within the main body and shielded by said boundary surfaces.

19. A method for manufacturing a light guide plate, comprising the following steps:
providing a light guide plate preform; and
forming a plurality of light diffusing structures in the light guide plate preform.

20. The method as claimed in claim 19, wherein the light diffusing structures are formed by an engraving method.
